(19) United States
(12) Patent Application Publication
(10) Pub. No.: US 2026/0134303 A1
(43) Pub. Date: May 14, 2026

(54) OPERATIONS SUPPORT APPARATUS AND NON-TRANSITORY COMPUTER READABLE MEDIUM

(71) Applicant: TOYOTA JIDOSHA KABUSHIKI KAISHA, Toyota-shi (JP)

(72) Inventors: Masayuki OKAMOTO, Nagoya-shi (JP); Manabu OKUYAMA, Nisshin-shi (JP); Naoki YAMAMURO, Nagoya-shi (JP); Yasuomi TAKEUCHI, Toyota-shi (JP)

(73) Assignee: TOYOTA JIDOSHA KABUSHIKI KAISHA, Toyota-shi (JP)

(21) Appl. No.: 19/353,864

(22) Filed: Oct. 9, 2025

(30) Foreign Application Priority Data
Oct. 31, 2024 (JP) 2024-192493

(51) Int. Cl. G06N 5/022; G06F 18/21

(52) U.S. Cl. CPC G06N 5/022; G06F 18/217

(57) ABSTRACT

An operations support apparatus includes a controller configured to give, upon receiving input of an issue related to operations from a user, the input to a model that has learned a plurality of items of know-how related to the operations, acquire information on a solution to the issue utilizing at least one item of know-how included in the plurality of items of know-how and a versatility score indicating versatility of the at least one item of know-how from the model, and output toward the user the information on the solution and the versatility score that are acquired. The model is, for example, generative artificial intelligence.

### CROSS-REFERENCE TO RELATED APPLICATION

This application claims priority to Japanese Patent Application No. 2024-192493 filed on October 31, 2024, the entire contents of which are incorporated herein by reference.

### TECHNICAL FIELD

The present disclosure relates to an operations support apparatus and a program.

### BACKGROUND

Patent Literature (PTL) 1 discloses creating second-level script data based on first-level script data, and outputting a lecture including audio that vocalizes text data of the second-level script data and video of an avatar instructor.

### CITATION LIST

### Patent Literature

PTL 1: JP 7473270 B1

### SUMMARY

PTL 1 does not consider a method for evaluating the versatility of know-how. It is conceivable to utilize the know-how learned by models such as generative AI in operations, but if the evaluation of the versatility of the know-how is known, it will be easier for users to determine how to utilize it. The term "AI" is an abbreviation of artificial intelligence.

It would be helpful to provide useful information to users who are trying to utilize the know-how learned by models in operations.

An operations support apparatus according to the present disclosure includes a controller configured to: give, upon receiving input of an issue related to operations from a user, the input to a model that has learned a plurality of items of know-how related to the operations; acquire information on a solution to the issue utilizing at least one item of know-how included in the plurality of items of know-how and a versatility score indicating versatility of the at least one item of know-how from the model; and output toward the user the information on the solution and the versatility score that are acquired.

According to the present disclosure, it is possible to provide useful information to users who are trying to utilize the know-how learned by models in operations.

### BRIEF DESCRIPTION OF THE DRAWINGS

In the accompanying drawings:

FIG. 1 is a block diagram illustrating a configuration of a know-how utilization system according to an embodiment of the present disclosure; and

FIG. 2 is a flowchart illustrating operations of an operations support apparatus according to the embodiment of the present disclosure.

### DETAILED DESCRIPTION

An embodiment of the present disclosure will be described below, with reference to the drawings. In the drawings, the same or corresponding portions are denoted by the same reference numerals. In the descriptions of the present embodiment, detailed descriptions of the same or corresponding portions are omitted or simplified as appropriate.

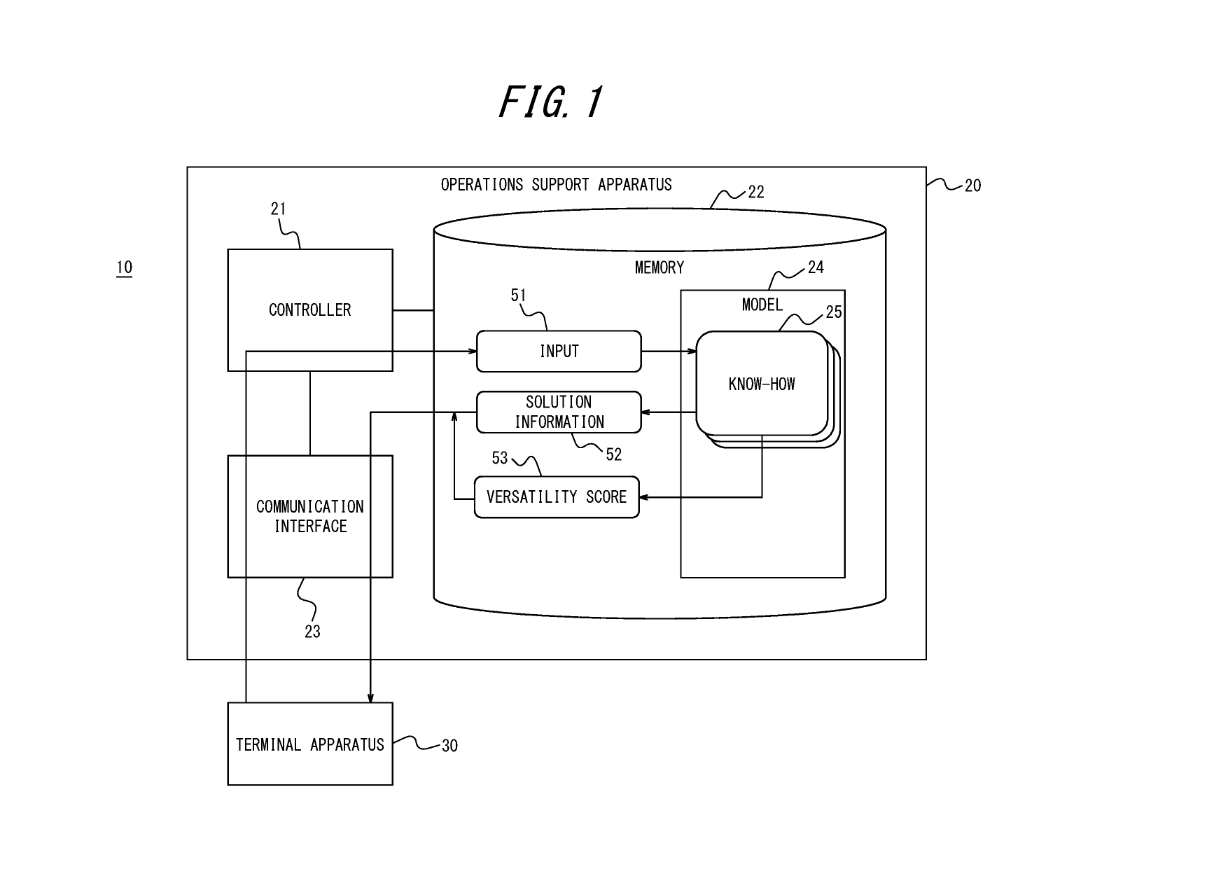

A configuration of a know-how utilization system 10 according to the present embodiment will be described with reference to FIG. 1.

The know-how utilization system 10 includes an operations support apparatus 20 and a terminal apparatus 30. The operations support apparatus 20 can communicate with the terminal apparatus 30 directly or via a network. The network includes the Internet, at least one WAN, at least one MAN, or any combination thereof. The term "WAN" is an abbreviation of wide area network. The term "MAN" is an abbreviation of metropolitan area network.

The operations support apparatus 20 is a computer that belongs to a cloud computing system or other computing system installed in a facility such as a data center. The operations support apparatus 20 includes a controller 21, a memory 22, and a communication interface 23.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term "CPU" is an abbreviation of central processing unit. The term "GPU" is an abbreviation of graphics processing unit. The programmable circuit is, for example, an FPGA. The term "FPGA" is an abbreviation of field-programmable gate array. The dedicated circuit is, for example, an ASIC. The term "ASIC" is an abbreviation of application specific integrated circuit. The controller 21 executes processes related to operations of the operations support apparatus 20 while controlling components of the operations support apparatus 20.

The memory 22 includes at least one semiconductor memory, at least one magnetic memory, at least one optical memory, or any combination thereof. The semiconductor memory is, for example, RAM, ROM, or flash memory. The term "RAM" is an abbreviation of random access memory. The term "ROM" is an abbreviation of read only memory. The memory 22 functions as, for example, a main memory, an auxiliary memory, or a cache memory. The memory 22 stores information to be used for the operations of the operations support apparatus 20 and information obtained by the operations of the operations support apparatus 20.

The communication interface 23 includes at least one communication module. The communication module is, for example, an interface compatible with LAN communication standards. The term "LAN" is an abbreviation of local area network. The communication interface 23 communicates with the terminal apparatus 30. The communication interface 23 receives information to be used for operations of the operations support apparatus 20 and transmits information obtained by the operations of the operations support apparatus 20.

The functions of the operations support apparatus 20 are realized by execution of a program according to the present embodiment by a processor serving as the controller 21. That is, the functions of the operations support apparatus 20 are realized by software. The program causes a computer to execute the operations of the operations support apparatus 20, thereby causing the computer to function as the operations support apparatus 20.

The program can be stored on a non-transitory computer readable medium. The non-transitory computer readable medium is, for example, flash memory, a magnetic recording device, an optical disc, a magneto-optical recording medium, or ROM. The program is distributed by sale, transfer of ownership, or rental of a portable medium on which the program is stored. The program may be distributed by storing the program in a storage of a server and transferring the program from the server to another computer. The program may be provided as a program product.

For example, the computer temporarily stores, in a main memory, the program stored in the portable medium or the program transferred from the server. Then, the computer reads the program stored in the main memory using the processor, and executes processes in accordance with the read program using the processor. The computer may read the program directly from the portable medium, and execute processes in accordance with the program. The computer may, each time a program is transferred from the server to the computer, sequentially execute processes in accordance with the received program. The program encompasses information that is to be used for processing by an electronic computer and is thus equivalent to a program. For example, data that is not a direct command to a computer but has a property that regulates processing of the computer is "equivalent to a program" in this context.

Some or all of the functions of the operations support apparatus 20 may be realized by a programmable circuit or a dedicated circuit serving as the controller 21. That is, some or all of the functions of the operations support apparatus 20 may be realized by hardware.

The terminal apparatus 30 is a mobile device such as a smartphone or tablet, or a PC that is used by the user. The term "PC" is an abbreviation of personal computer.

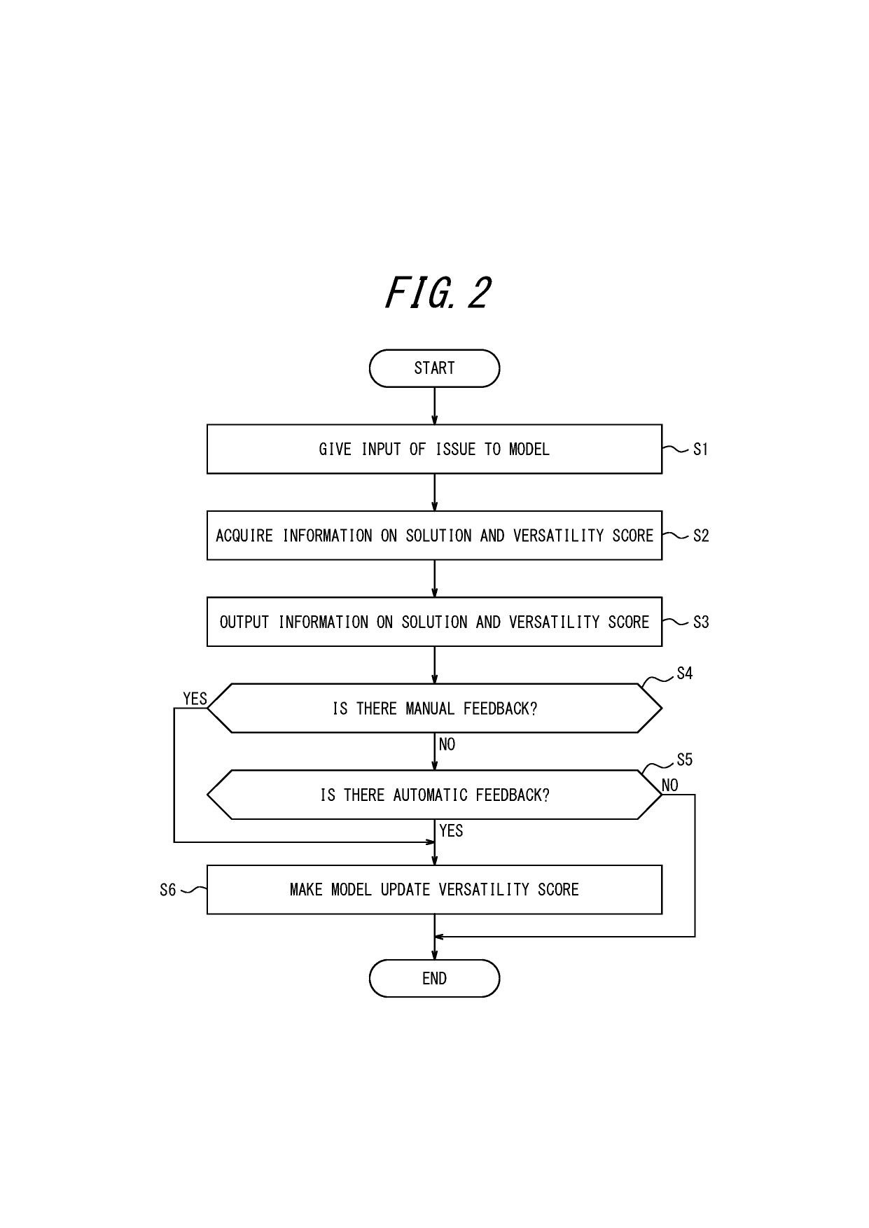

Operations of the operations support apparatus 20 according to the present embodiment will be described with reference to FIG. 2. The operations described below correspond to an operations support method according to the present embodiment. In other words, the operations support method according to the present embodiment includes steps S1 to S6 illustrated in FIG. 2.

When the user inputs an issue related to operations into the terminal apparatus 30, the terminal apparatus 30 transmits the input of the issue 51 to the operations support apparatus 20. The controller 21 receives input 51 from the terminal apparatus 30 via the communication interface 23. When the controller 21 receives input 51 from the terminal apparatus 30, that is, when it receives input 51 of the issue from the user via the terminal apparatus 30, in S1, it provides input 51 to the model 24 that has learned a plurality of items of know-how 25 related to the operations. Know-how 25 refers to specific or specialized knowledge, techniques, methods, or information. Know-how 25 is typically conveyed through explanations in words, images, or actions. Examples of applications for know-how 25 include tasks such as screwing or assembly, operation of applications or software, or procedures for performing operations, but the applications are not limited to these. Know-how 25 is accumulated and learned as text, electronic documents, audio, images, or any combination of these. Know-how 25 includes insights gained by veterans or experts in a specific field, practical techniques or methods cultivated through experience in that field, or all of these. Model 24 is, for example, a generative AI such as an LLM, which outputs text corresponding to a prompt input from the user. "LLM" is an abbreviation for large language model. Model 24 may output information in forms other than text, such as images, in addition to or instead of text.

In S2, the controller 21 acquires solution information 52 and versatility score 53 from model 24. Solution information 52 is information about solutions to the issue utilizing at least one of the plurality of items of know-how 25. Versatility scores 53 is a score indicating the versatility of at least one of the know-hows 25. Versatility scores 53 indicates the degree of generality of knowledge, such as whether the knowledge explained by a veteran refers to specific numerical values or specifications, or whether the numbers are just examples and the relationship is proportional, etc. For example, in the task of screwing, the expansion of screw parts changes due to environmental factors such as temperature, so which parts to use changes. Therefore, the versatility score 53 may be low. As another example, in regular meetings such as morning or lunch meetings, the way the meeting proceeds changes depending on whether there is a decision-maker, whether it is face-to-face or remote, what meeting tools are used if remote, or whether there is a time difference among participants. Therefore, the versatility score 53 may be low.

The initial value of the versatility score 53 may be a fixed value, a manually set value, or a variable value according to the range of users involved. In the case of a manually set value, initially, a person sets the value, the AI learns how to set it, and from then on, the AI may automatically set the value. In the case of a variable value, it is conceivable to adjust the value depending on whether the document from which knowledge is acquired, such as a procedure manual, is intended for all employees or for a specific department.

As a versatility score 53, either one or both of the scores of the first type and the second type may be set. For example, if the first type of score is high regarding the know-how of using a certain part in a process, it suggests that the part can be used anytime and anywhere; if the score is low, it suggests that the parts that can be used change depending on the time and place. However, the process does not change. On the other hand, if the second type of score is high, it suggests that the part can be used in another process, and if the score is low, it suggests that the part can only be used in the same process.

In S3, the controller 21 outputs the solution information 52 and the versatility score 53 obtained in S2 to the user. Specifically, the controller 21 transmits the solution information 52 and the versatility score 53 to the terminal apparatus 30 via the communication interface 23. When the terminal apparatus 30 receives the solution information 52 and the versatility score 53 from the operations support apparatus 20, it outputs the received solution information 52 and versatility score 53 to the user by displaying it on the screen or through voice output.

In S4, the controller 21 determines the presence or absence of manual feedback. Manual feedback refers to feedback input by the user regarding the usefulness of the solution of the solution information 52. When the controller 21 determines that there is manual feedback, it updates the versatility score 53 by providing the manual feedback to the model 24 in S6. If there is no manual feedback, the step of S5 is executed. Alternatively, if there is manual feedback, the step of S5 may be further executed.

For example, let’s assume that the solution information 52 includes a solution that uses a certain part. The user asks one or more veterans whether to use this part, and if consent is obtained, inputs that information as positive manual feedback into the terminal apparatus 30. The terminal apparatus 30 transmits the positive manual feedback to the operations support apparatus 20. The controller 21 receives the positive manual feedback from the terminal apparatus 30 via the communication interface 23. When the controller 21 receives the positive manual feedback from the terminal apparatus 30, that is, when it receives positive manual feedback via the terminal apparatus 30, it raises the versatility score 53 in the model 24. On the other hand, if the user does not obtain consent, they input that information as negative manual feedback into the terminal apparatus 30. The terminal apparatus 30 transmits the negative manual feedback to the operations support apparatus 20. The controller 21 receives the negative manual feedback from the terminal apparatus 30 via the communication interface 23. When the controller 21 receives negative manual feedback from the terminal apparatus 30, that is, when it receives negative manual feedback via the terminal apparatus 30, it lowers the versatility score 53 of the model 24. The more people agree, the versatility score 53 may be increased. Negative manual feedback may be input when the user cannot use the solution during daily application of the solution or when warned by a veteran.

In S5, the controller 21 determines the presence or absence of automatic feedback. Automatic feedback refers to the results of judgments or comparisons made by the controller 21. The judgment includes whether the user actually applied the solution of the solution information 52 or whether the user judged the results of applying the solution of the solution information 52. The comparison involves acquiring information on a first environment where at least one of the know-how 25 mentioned above has been applied, and when the user actually applied a different solution from the solution information 52, acquiring information on a second environment where that different solution has been applied, and comparing the acquired information on the second environment with the information on the first environment. The first environment and the second environment may be, for example, region, weather, or temperature. When the controller 21 determines that there is automatic feedback, in S6, it provides the automatic feedback to the model 24 to update the versatility score 53. If there is no automatic feedback, the flow illustrated in FIG. 2 ends.

As an example, when the controller 21 senses the user's behavior with a camera or sensor and determines that the user actually applied the solution of the solution information 52, it raises the versatility score 53 of the model 24. On the other hand, when the controller 21 determines that the user did not actually apply the solution of the solution information 52, it lowers the versatility score 53 of the model 24. As another example, when the controller 21 determines that the value presented in the solution information 52 is the same as the value actually used by the user, it raises the versatility score 53 of the model 24. On the other hand, when the controller 21 determines that the value presented in the solution information 52 is different from the value actually used by the user, it lowers the versatility score 53 of the model 24. Even if the values are different, if the user uses the same value every day, it may be suspected that the solution is incorrect, and the corresponding know-how 25 may be updated. The adjustment of the versatility score 53 or the update of the know-how 25 may be performed after confirming with the user. When the user informs that know-how 25 could be applied in a different process than know-how 25, it may raise the versatility score 53. Alternatively, know-how 25 may be added without raising the versatility score 53.

According to this embodiment, the versatility of know-how 25 can be evaluated. When utilizing the learned know-how 25 of the model 24 in operations, knowing the evaluation of the versatility of know-how 25 makes it easier for users to determine how to utilize it. That is, it is possible to provide useful information to users who are trying to utilize the know-how learned by model 24 in operations.

The present disclosure is not limited to the embodiment described above. Modifications can be made without departing from the spirit of the present disclosure.

1. An operations support apparatus comprising a controller configured to:
give, upon receiving input of an issue related to operations from a user, the input to a model that has learned a plurality of items of know-how related to the operations;
acquire information on a solution to the issue utilizing at least one item of know-how included in the plurality of items of know-how and a versatility score indicating versatility of the at least one item of know-how from the model; and
output toward the user the information on the solution and the versatility score that are acquired.

2. The operations support apparatus according to claim 1, wherein the controller is configured to give, upon receiving feedback on usefulness of the solution from the user, the feedback to the model to make the model update the versatility score.

3. The operations support apparatus according to claim 1, wherein the controller is configured to:
determine whether the user has actually applied the solution or a result of the user actually applying the solution; and
give a determination result to the model to make the model update the versatility score.

4. The operations support apparatus according to claim 1, wherein the controller is configured to:
acquire information on a first environment where the at least one item of know-how has been applied;
acquire, in a case in which the user has actually applied a different solution from the solution, information on a second environment where the different solution has been applied;
compare the acquired information on the second environment with the information on the first environment; and
give a comparison result to the model to make the model update the versatility score.

5. A non-transitory computer readable medium storing a program configured to cause a computer to function as the operations support apparatus according to claim 1.
